(19) United States
(12) Patent Application Publication
(10) Pub. No.: US 2026/0130399 A1
(43) Pub. Date: May 14, 2026

(54) Gluten-Free Flour Composition

(71) Applicant: John C. Limm, Robbinsville, NJ (US)

(72) Inventor: John C. Limm, Robbinsville, NJ (US)

(21) Appl. No.: 19/007,395

(22) Filed: Dec. 31, 2024

Related U.S. Application Data
(60) Provisional application No. 63/719,726, filed on Nov. 13, 2024.

(51) Int. Cl. A23L 7/10; A21D 2/36; A23L 33/105

(52) U.S. Cl. CPC A23L 7/198; A21D 2/36; A23L 7/197; A23L 33/105

(57) ABSTRACT

A gluten-free flour composition that can be substituted for wheat flour. The gluten-free flour composition contains at least 90% by weight of brown rice flour. The brown rice flour is mixed with slippery elm leaf powder and/or okra powder. The added powder(s) provide structural proteins to the brown rice flour. Once mixed, the brown rice flour and the secondary powders create a gluten-free composition that is capable of creating dough that has similar viscoelastic properties to whole wheat flour. Furthermore, the gluten-free composition nurtures the growth of yeast in a manner similar to that of wheat flour. This enables the dough to rise and expand in the same manner as wheat dough. The added powders add structural proteins to the already nutritious brown rice flour. The result is a gluten-free composition that contains as much protein and nutrition as does traditional whole wheat flour.

### RELATED APPLICATIONS

This application claims the benefit of U.S. Provisional Application No. 63/719,726, filed Nov. 13, 2024.

### FIELD OF THE INVENTION

The present invention relates to compositions that can serve as gluten-free substitutes to wheat-based flour. More particularly, the present invention relates to compositions that mix brown rice flour with one or more other ingredients to provide the brown rice flour with characteristics more similar to wheat flour when used in baked goods.

### BACKGROUND OF THE INVENTION

Gluten is a structural protein that is naturally found in wheat, barley, rye, and some cultivars of oats. Gluten is the term that usually refers to the elastic structural proteins within a wheat grain, which primarily include gliadin and glutenin. Accordingly, gluten is present in flour that is made from such grains. Gluten has viscoelastic and adhesive properties, which give dough elasticity. This helps dough rise and keep its shape. When flour with gluten is used in dough, the gluten greatly affects the consistency of the dough. Prior to baking, the gluten enables the dough to be stretched, folded and repeatedly kneaded without breaking apart. After baking, the presence of gluten provides the final product with a soft, chewy texture.

In bread wheat, the presence of gluten accounts for up to 85% of the total protein. Although gluten rich flours are preferred in many baking recipes, some people have adverse reactions to consuming gluten. Many people react to gluten by feeling bloated and having trouble with digestion. Some people have allergic reactions, where the consumption of gluten can cause swelling and hives. Still others have Celiac Disease where the digestive tract can become damaged from the consumption of gluten. This causes the digestive tract to lose its ability to absorb nutrients. This can lead to malnutrition, weight loss, fatigue, delayed growth, and failure to thrive in infants.

The simplest treatment for people who are sensitive to gluten is to avoid products that contain gluten. That is, the simplest treatment is to avoid products that contain wheat flour. There are many gluten-free flours in the marketplace, such as rice flour, sorghum flour and tapioca flour that can be used in baking. However, these alternate flours do not provide the same viscoelastic properties to the recipe as would a wheat flour with gluten. The result is typically a baked good that is brittle and flat.

In the prior art, there have been many attempts to make a gluten-free flour that can create a viscoelastic dough similar to that of wheat flour. This is typically done by mixing white rice flour with a starch and a gum. The starch is typically potato starch or corn starch, which helps bind the flour together. The gum is typically xanthan gum or guar gum, which provides some elastic characteristics to the dough being produced. Such prior art compositions are exemplified by U.S. Patent Application Publication No. 2014/0322390 to Papanastasiou and U.S. Patent Application Publication No. 2018/0279628 to Routson.

One way to make non-wheat flour perform more like wheat flour is to add non-gluten structural proteins to the non-wheat flour. One of the most common non-wheat flours used to make gluten free flour is white rice flour, which is known in the food industry simply as “rice flour”. White rice flour is often used as a base because white rice flour is both inexpensive and plentiful. Furthermore, white rice flour is smoother and more visually and tactilely akin to white wheat baking flour than flour made from brown rice. However, dough made from white rice flour is very inelastic. To make the white rice flour perform more like wheat flour when baking, many protein-rich additives have been mixed with the white rice flour. These protein additives include okra powder in various concentrations with other additives. Gluten-free flours that mix okra with white rice flour are exemplified by CN104336480A, CN111513113A, CN109463417B, and the publication by Chan D S, Wang S T, Chen M Y, Sung W C, entitled “The effect of okra (Abelmoschus esculentus l.) Powder Addition on Qualities of Gluten-free Chiffon Cake”, Food Sci Technol Int. 2024 July; 30(5):485-494.

Mixing white rice flour with okra powder improves the texture of the flour. However, in order to make the white rice flour as nutritious and protein-rich as wheat flour, many additional ingredients must be added. The result is a rice-based flour that has many ingredients. This makes the flour both difficult and expensive to produce. As such, the cost of a bag of gluten-free flour can be many times more expensive than a similarly sized bag of regular wheat flour. In addition, although the use of additives helps, the gluten-free flour still does not produce an elastic dough that is comparable to wheat flour dough.

A need therefore exists for an improved composition for a gluten-free flour that is more nutritious, less complicated to make, less expensive to produce, and is capable of creating a dough with viscoelastic properties similar to that of wheat dough. These needs are met by the present invention as described and claimed below.

### SUMMARY OF THE INVENTION

The present invention is a gluten-free flour composition that can be substituted for wheat flour when cooking or baking. The gluten-free flour composition contains at least 90% by weight of brown rice flour. Brown rice flour is obtained by milling whole grain brown rice, therein retaining the nutritional value of brown rice.

The brown rice flour is mixed with slippery elm leaf powder and/or okra powder. The added powder(s) provide structural proteins to the brown rice flour. Once mixed, the brown rice flour and the secondary powders create a gluten-free composition that is capable of creating dough that has similar viscoelastic properties to whole wheat flour. Furthermore, the gluten-free composition nurtures the growth of yeast in a manner similar to that of wheat flour. Due to the elasticity of the dough, the dough can retain the carbon dioxide bubbles produced by the yeast in the same manner as wheat dough. This enables the dough to rise and expand in the same manner as wheat dough.

The added powders add structural proteins to the already nutritious brown rice flour. The result is a gluten-free composition that contains as much protein and nutrition as does traditional whole wheat flour.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 shows a schematic of the methodology needed to formulate the present invention composition;

FIG. 2 shows a schematic of the testing procedure used to determine the viscoelastic properties of samples;

FIG. 3 is a graph showing test results for a composition of a dough made from a first formulation of a gluten-free flour;

FIG. 4 is a graph showing test results for a composition of a dough made from a second formulation of a gluten-free flour;

FIG. 5 is a graph showing test results for a composition of a dough made from a third formulation of a gluten-free flour;

FIG. 6 is a graph showing test results for a composition of a dough made from a fourth formulation of a gluten-free flour; and

FIG. 7 is a graph showing test results for a composition of a dough made from a fifth formulation of a gluten-free flour.

### BRIEF DESCRIPTION OF THE INVENTION

Although the present invention gluten-free flour formulation can be embodied in many ways, only a few exemplary formulations are illustrated and described. The exemplary formulations are being shown for the purposes of explanation and description. The exemplary formulations are selected in order to set forth some of the best modes contemplated for the invention. The described formulations, however, are merely exemplary and should not be considered as limitations when interpreting the scope of the appended claims.

Oryza sativa is the most common species of cultivated rice and is subdivided into long-grain indica and short-grain japonica. When the rice is grown, brown rice is considered the whole grain portion of the rice seed that contains both the bran and the germ. White rice is a mechanically processed grain that has the bran and the germ removed to make the rice softer and faster to cook. Since brown rice contains the bran and the germ, the brown rice contains more fiber, vitamins and minerals than does white rice. Furthermore, brown rice contains significantly more fatty acids and lipids than does the processed white rice.

One cup of brown rice has approximately 3.5 grams of fiber, which is close to 10 percent of the daily recommended allowance. The fiber in brown rice promotes healthy digestion and prevents both constipation and diverticulosis. The fiber reduces cholesterol levels and minimizes the amount of time that ingested cancer-causing compounds spend in contact with colon cells.

Brown rice is a good source of magnesium. One cup of brown rice contains approximately 86 mg of magnesium, which is over 20 percent of the recommended daily allowance. Magnesium helps metabolism and strengthens bones. Magnesium is also known to reduce the severity of asthma, lower blood pressure, reduce migraine severity and reduce the risk of heart attack and stroke.

Brown rice also contains the minerals manganese, selenium, and zinc. One cup of brown rice contains over 88 percent of the recommended daily allowance of manganese, 27 percent of the recommended daily allowance of selenium, and over 10 percent of the recommended daily allowance of zinc. Manganese is important in the synthesis of fatty acids and for the functioning of the central nervous system. Selenium reduces the risk of colon cancer and aids in both thyroid hormone metabolism and immune function. Zinc is an antioxidant that removes free radicals and aids in wound healing. Zinc also assists in the proper functioning of the immune system.

In addition, one cup of brown rice contains approximately 25 percent of the recommended daily allowance of vitamin B6. Vitamin B6 is vital in the production of serotonin, red blood cells, and DNA. The brown rice also contain lignans, which are phytonutrients that protect against hormone related cancers, such as breast cancer. Furthermore, brown rice is a whole grain, and it is known that a diet heavy in whole grains lowers LSL cholesterol, lowers the risks of diabetes, prevents gallstones, and lowers the occurrences of childhood asthma.

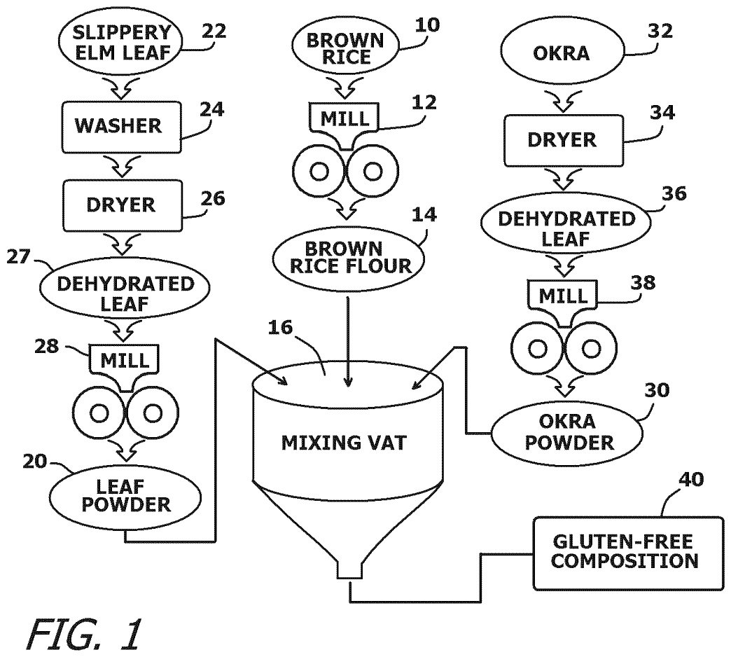

Referring to FIG. 1, it can be seen that the brown rice 10 is grown, harvested and dried in traditional manners. The dry brown rice 10 is then processed in a mill 12. This produces brown rice flour 14. The brown rice flour 14 is advanced into a mixing vat 16. As will be explained in greater detail, the brown rice flour 14 is mixed with slippery elm leaf powder 20 and/or okra powder 30. These secondary ingredients add complex structural proteins to the brown rice flour 14 that bind the particles of flour and add significant viscoelasticity to dough produced from the formulation. This produces a gluten-free flour composition 40 that has similar characteristics to whole wheat flour when used in baking recipes.

The brown rice flour 14 can be mixed with leaf powder 20 made from leaves of the Ulmus rubra, or Slippery Elm tree. The tree genus Ulmus rubra is a tree commonly found throughout eastern North America and east Asia. The leaves of the Ulmus rubra tree are classified by the FDA as “generally recognized as safe” or GRAS. One mature Ulmus rubra tree can hold about five-hundred pounds of leaves at any one time in a season. As such, if selectively pruned, a single Ulmus rubra tree can produce from 500 to 1000 pounds of green leaves through a single season. Thus, large volumes of Ulmus rubra tree leaves can be readily obtained at low costs.

The leaves of the Ulmus rubra tree contain long chain structural proteins that are sticky or slimy, therein providing the slippery elm tree with its common name. When mixed with brown rice flour 14, the proteins of the Ulmus rubra leaves bind the brown rice flour molecules in a manner very similar to the gliadin and glutenin proteins of gluten. The result is a mixed two-ingredient gluten-free flour that has improved elasticity when turned into dough and baked.

The green leaves 22 of the Ulmus rubra tree are harvested and washed in a wash plant 24. The clean leaves are then either vacuum dried and/or freeze dried in a commercial dryer 26, such as a vacuum dehydrator or freeze dryer. This produces dehydrated leaves 27. The dehydrated leaves are then ground in a mill 28 to produce leaf powder 20. The average particle size of the leaf powder 20 of between 10 um and 100 um is preferred so that the particle size is generally equivalent to that of the brown rice flour 14.

Okra powder 30 can be used in conjunction with, or in place of, the leaf powder 20 from the slippery elm. Okra 32 is the name given to the edible seed pod of the plant Abelmoschus esculentus. Okra 32 is high in vitamins A, C, K and B6. Okra 32 is a good source of magnesium and folates. Okra 32 is often considered a superfood and a known antioxidant with the ability to lower cholesterol and blood sugar levels.

The okra 32 is harvested, cleaned, and is then dried in a vacuum dehydrator or similar commercial dryer 34. This produces dried okra 36. The dried okra 36 is then ground into a powder in a mill 38. The okra powder 30 has an average particle size between 10 um and 100 um that is generally equivalent to that of the brown rice flour 14 and the leaf powder 20.

The slippery elm leaf powder 20 and/or the okra powder 30 are added to the brown rice flour 14 in the mixing vat 16. In the mixing vat 16, the composition is preferably between 90 percent and 99 percent brown rice flour (by weight) to 1.0 percent to 10 percent of the other powder/powders (by weight).

Once in the mixing vat 16, the brown rice flour 14, the slippery elm leaf powder 20 and/or the okra powder 30 are thoroughly mixed. This produces a homogenous gluten-free flour composition 40 that has a light brown color similar to that of whole grain wheat flour. When used in a recipe to produce a dough, the gluten-free flour composition 40 readily mixes with both water and oils and produces a highly elastic dough. The viscoelasticity of the dough is enhanced by the fatty acids and lipids in the brown rice flour 14, as well as the structural proteins contained in the slippery elm leaf powder 20 and/or the okra powder 30. As such, the use of brown rice flour 14 produces a significantly better wheat flour substitute than does white rice flour. Use of the brown rice flour 14 also makes the gluten-free composition 40 more nutritious. As a result, baked goods made from the brown rice based flour composition 40 are at least as nutritious and protein packed as are baked goods made from whole wheat flour.

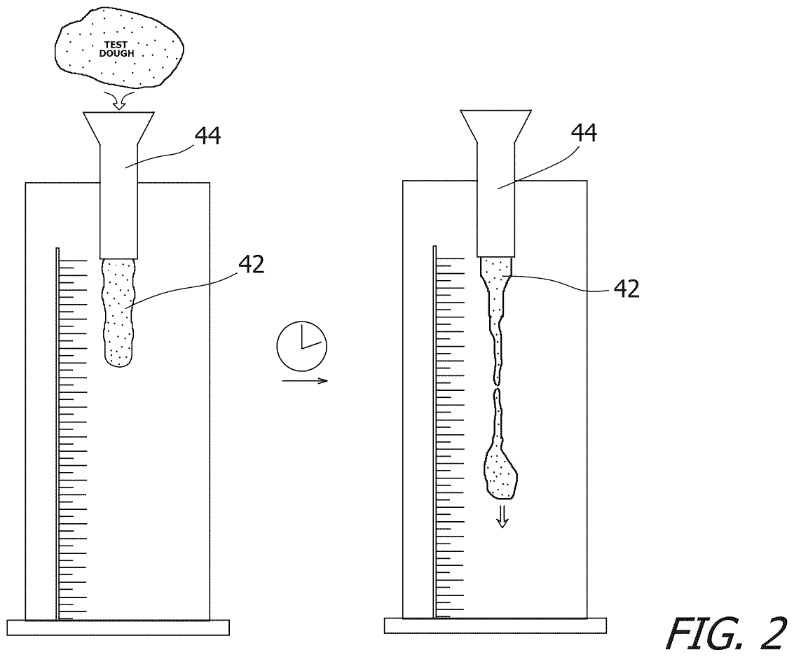

Formulations of the gluten-free flour composition were tested in comparisons with two test controls. The first test control is a dough made from whole wheat flour and water. The whole wheat dough is 5%-7% water by weight. The second test control is a dough made purely from brown rice flour and water. The brown rice dough is 5%-7% water by weight. The test performed is a viscoelasticity test. Referring to FIG. 2, it can be seen that a tube of test material 42 is extruded from a tube 44 that is exactly one centimeter in diameter. Ten (10) centimeters of the test material 42 is then extruded, wherein the extruded test material 42 hangs freely from the tip of the extrusion tube 44. The test measures how far the test sample elongates over time under the force of gravity before the test sample fails. This test provides a direct indication of the viscoelasticity of the dough being tested. Dough with high viscoelasticity will deform significantly before breaking. Dough with low viscoelasticity will break more rapidly with less deformation. The goal is to produce a gluten-free dough that has viscoelastic characteristics similar to that of the whole wheat control.

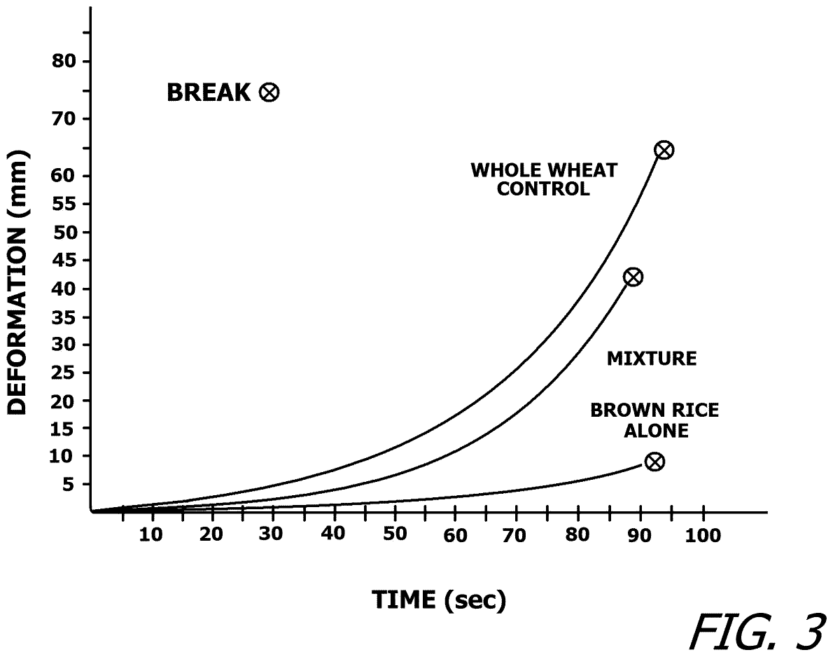

Referring to FIG. 3 the results of a first test set are presented. In the first test set, a gluten-free test dough is produced by mixing brown rice flour with both slippery elm leaf powder and okra powder in the percentages listed below.

TEST COMPOSITION 1

| Dry mix | |
|---|---|
| Brown Rice flour - | 90% |
| Slippery Elm Leaf powder- | 5% |
| Okra powder- | 5% |

Plus water -- 5%-7% by weight of dry mix.

Plus water—5%-7% by weight of dry mix.
   As can be seen from the results of the test shown in FIG. 3, the addition of slippery elm leaf powder and okra powder to the brown rice improves the quality of the dough significantly. The viscoelastic characteristics of the dough are much closer to that of whole wheat flour. The viscoelastic characteristics of the test dough are further improved if the dough is leavened with yeast.

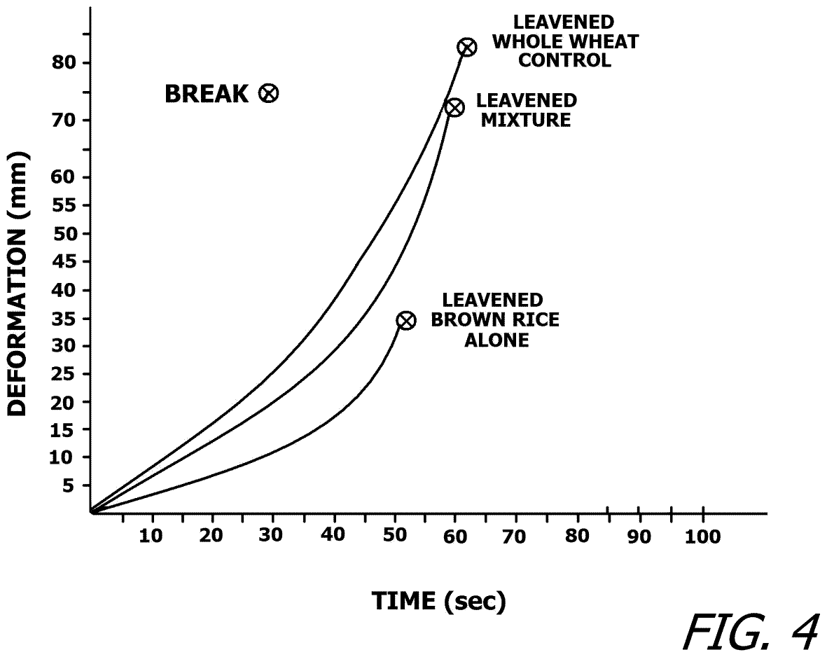

To leaven the dough being tested, the dough is mixed with activated yeast and is provided time to proof at room temperature for four hours. Referring to FIG. 4, it can be seen that when leavened with yeast, the viscoelasticity of the test dough is only a few percentages below the viscoelasticity of leavened wheat. Accordingly, in a recipe that calls for whole wheat flour, the composition of Test Composition 1 can be substituted with only a minor change to any dough being produced. The difference between the composition of Test Composition 1 and whole wheat flour would be unnoticeable to most all amateur bakers.

If mixed with yeast in a recipe, the gluten-free composition nurtures the growth of yeast in a manner similar to that of wheat flour. Furthermore, due to the elasticity of the dough, the dough can retain the carbon dioxide bubbles produced by the yeast in the same manner as wheat dough. This enables the dough to rise and expand in the same manner as wheat dough.

The composition in FIG. 3 and FIG. 4 uses both slippery elm leaf powder and okra powder in equal measures. This composition can be varied through a wide range of mixture ratios, provided the brown rice flour remains over 90% of the dry mix. Furthermore, high quality gluten-free flour can also be produced by using only slippery elm leaf powder or only okra powder.

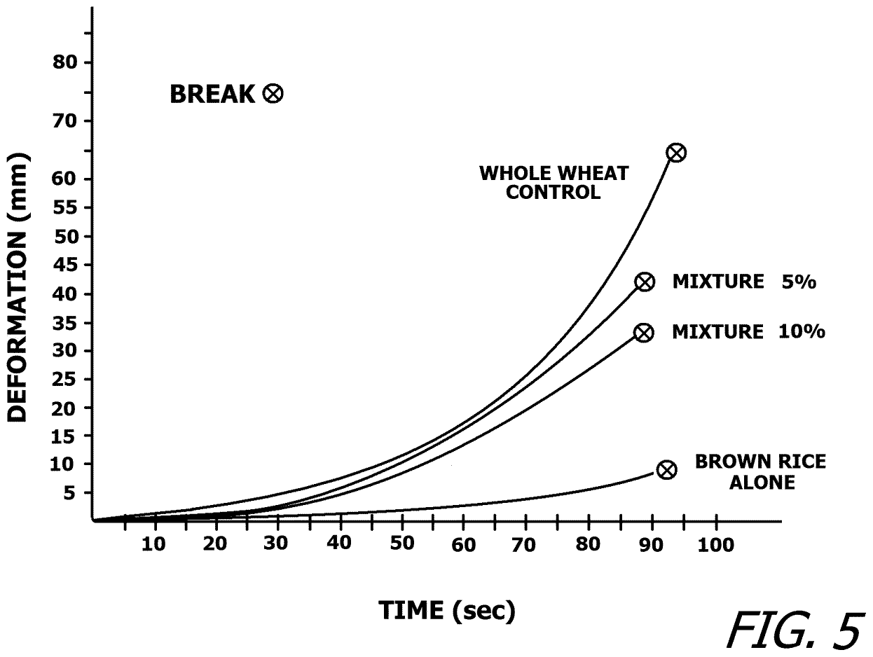

Referring to FIG. 5 the results of a third test set are presented. In the third test set, a gluten-free test dough is produced by mixing brown rice flour with only slippery elm leaf powder in the percentages listed below.

TEST COMPOSITION 2

| Dry mix | |
|---|---|
| Brown Rice flour - | 95% & 90% |
| Slippery Elm Leaf powder- | 5% & 10% |

Plus water -- 5%-7% by weight of dry mix.

As can be seen from the results of the test shown in FIG. 5, the addition of slippery elm leaf powder to the brown rice powder improves the quality of the dough significantly. The viscoelastic characteristics of the dough are much closer to that of whole wheat flour. The viscoelastic characteristics of the test dough are further improved if the dough is leavened with yeast.

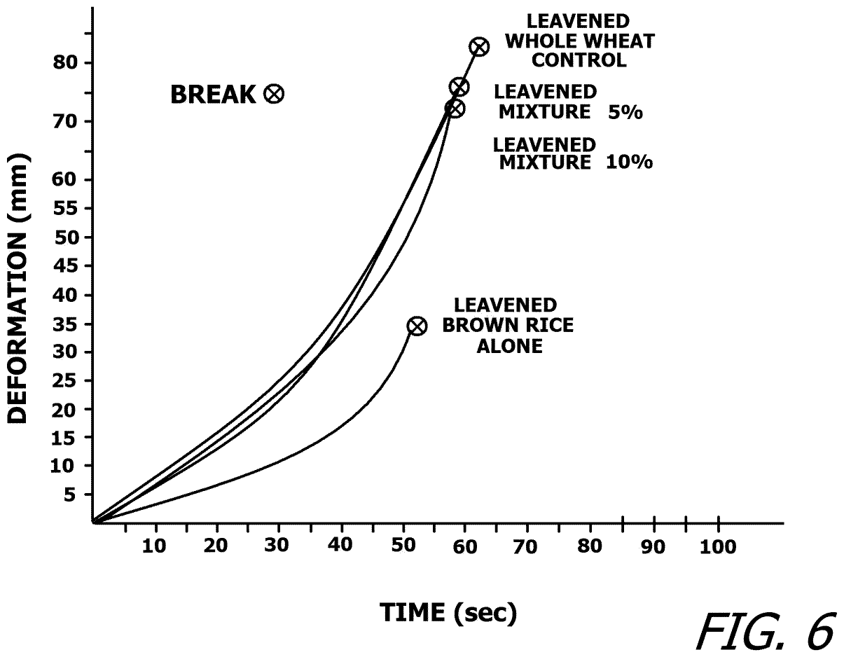

To leaven the dough being tested, the dough is mixed with activated yeast and is provided time to proof at room temperature for four hours. Referring to FIG. 6, it can be seen that when leavened with yeast, the viscoelasticity of the test dough only differs slightly from the viscoelasticity of leavened wheat. Accordingly, in a recipe that calls for whole wheat flour, the composition of Test Composition 2 can be substituted with no noticeable change to the dough being produced.

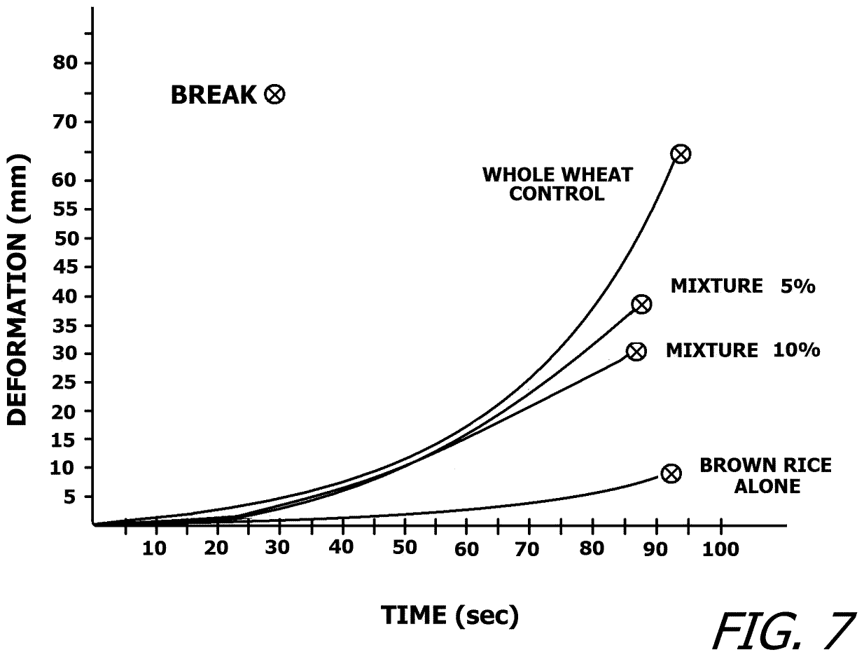

Referring to FIG. 7 the results of a fifth test set are presented. In the fifth test set, a gluten-free test dough is produced by mixing brown rice flour with only okra powder in the percentages listed below.

TEST COMPOSITION 3

| Dry mix | |
|---|---|
| Brown Rice flour - | 95% & 90% |
| Okra Powder - | 5% & 10% |

Plus water -- 5%-7% by weight of dry mix.

As can be seen from the results of the test shown in FIG. 7, the addition of okra powder to the brown rice powder improves the quality of the dough significantly. The viscoelastic characteristics of the dough are much closer to that of whole wheat flour. The viscoelastic characteristics of the test dough are further improved if the dough is leavened with yeast. When leavened with yeast, the viscoelasticity of the test dough only differs slightly from the viscoelasticity of leavened wheat. Accordingly, in a recipe that calls for whole wheat flour, the composition of Test Composition 3 can be substituted with no noticeable change to the dough being produced.

In all of the test compositions, the result is a gluten-free composition that can be substituted for wheat flour in most any recipe that calls for wheat flour. The gluten-free composition produces a dough that has high elasticity and the ability to rise with yeast.

One of the strictest tests for gluten-free flour is its ability to produce pizza dough. Pizza dough is rolled thin and is cooked at high temperatures. Once cooked, it is expected that the cooked dough will maintain a good degree of elasticity and that the cooked dough will flex and fold without breaking. Prior art rice-based flours cannot be used to create a pizza dough that is not overly brittle. Using the present invention gluten-free composition, a dough can be created that can be used to make pizza dough, wherein the dough is stiff enough to support a slice of pizza yet is elastic enough to enable a slice of pizza to be folded without breaking.

It will be understood that the embodiments of the present invention that are illustrated and described are merely exemplary and that a person skilled in the art can make many variations to those embodiments. All such embodiments are intended to be included within the scope of the present invention as defined by the claims.

1. A gluten-free dough composition, comprising:
at least 90% by weight of brown rice flour, wherein said brown rice flour contains particles of ground brown rice;
between 1% and 10% slippery elm leaf powder by weight, wherein said slippery elm leaf powder contains complex structural proteins; and
between 5% and 7% water by weight;
wherein said complex structural proteins bind together said particles of said brown rice flour, therein adding improved viscoelasticity to said gluten-free dough composition.

2. (canceled)

3. The gluten-free dough composition according to claim 1, wherein said water, said brown rice flour and said slippery elm leaf powder are the only ingredients in said gluten-free dough composition.

4. The gluten-free dough composition according to claim 2, further including between 1% and 9% okra powder by weight.

5. The gluten-free dough composition according to claim 4, wherein said slippery elm leaf powder and said okra powder are in equal measures.

6. A gluten-free dough composition, comprising:
at least 90% by weight of brown rice flour wherein said brown rice flour contains particles of ground brown rice;
between 1% and 10% by weight of ground okra powder wherein said okra powder contains complex structural proteins, and
between 5% and 7% water by weight,
wherein said complex structural proteins bind together said particles of said ground brown rice, therein adding improved viscoelasticity to said gluten-free dough composition.

7. The gluten-free dough composition according to claim 6, wherein said water, said brown rice flour and said okra powder are the only ingredients in said gluten-free flour composition.

8. The gluten-free dough composition according to claim 6, further including between 1% and 10% slippery elm leaf powder by weight.

9. The gluten-free dough composition according to claim 8, wherein said slippery elm leaf powder and said okra powder are in equal measures.

10. A method of making a gluten-free flour for cooking and baking, said method comprising the steps of:
milling whole grain brown rice into brown rice flour;
drying and milling leaves of a slippery elm tree to produce a leaf powder;
mixing said brown rice flour and said leaf powder to produce said gluten-free flour, wherein said gluten-free flour is at least 90 percent said brown rice flour by weight.

11. (canceled)

12. The method according to claim 10 further including mixing okra powder into said gluten-free flour.

13. The method according to claim 12, wherein said brown rice flour, said leaf powder, and said okra powder are the only ingredients in said gluten-free flour.

14. The method according to claim 10, further including mixing said gluten-free flour with water to form a dough, wherein said leaf powder contains complex structural proteins that bind together said particles of said brown rice flour, therein adding viscoelasticity to said dough.
